(19) United States
(12) Patent Application Publication
(10) Pub. No.: US 2009/0305551 A1
(43) Pub. Date: Dec. 10, 2009

(54) Electrical connector

(76) Inventor: Yasutoshi Kameda, Chiba (JP)

Correspondence Address: Harrington & Smith PC, 4 Research Drive, Suite 202, Shelton, CT, 06484, US

(21) Appl. No.: 11/631,540

(22) PCT Filed: Jul. 4, 2005
(86) PCT No.: PCT/JP2005/012343

§ 371 Date: Sep. 24, 2007

(30) Foreign Application Priority Data
Jul. 5, 2004 (JP) 2004-198208

(51) Int. Cl. H01R 13/658

(52) U.S. Cl. 439/497

(57) ABSTRACT

A differential transmission connector in which degradation of signal characteristics is improved. The connector being mated to a mating connector and making electrical connection of two or more differential transmission cables each having a pair of signal lines and at least one drain line, includes a contact for a pair of adjacent signal lines being connected with the pair of signal lines of the cable, a contact for the earth line being connected with the at least one drain line of the cable, a carrier having the contact for a pair of signal lines and the contact for the earth line arranged alternately in one row on an identical plane in the width direction intersecting the axial direction of the cable perpendicularly, and a shell covering the contact for signal lines, the contact for the earth line and the carrier, wherein a drain line located at least one end of the arrangement is connected with the shell.

### TECHNICAL FIELD

The present invention pertains to a connector capable of electrically connecting a differential transmission cable, and further relates to a connector offering good high-speed signal characteristics due to its characteristic configuration.

### BACKGROUND ART

With the increased information capacity and higher information transmission speeds of recent years, a data transfer specification known as serial ATA has become the standard interface between peripheral devices for personal computers and the like. Serial transmission refers to a format in which information is transmitted one bit at a time using a single transmission path. The smaller number of signal lines makes interference less likely to occur between signal lines, thus making serial transmission more advantageous for higher speeds. It is also advantageous in terms of the signal voltage, which can be set as low as about ±250 mV, and for being able to improve the resistance to noise from external sources by employing differential transmission, wherein an original signal and a signal obtained by polarity-inverting said signal are simultaneously transmitted on two signal lines. Such a transmission format requires two sets of two lines, for a total of four signal lines. A typical example is the USB format. However, further increases in information capacity will raise the demand for higher signal transfer rates and increased numbers of signal lines for greater information transmission, and require improvements in the resulting degradation of signal characteristics between signal lines. Solutions to these problems have been suggested as described in Patent Documents 1 and 2.

The differential transmission connector of Patent Document 1 has pairs of pin-shaped signal contacts arranged alternately in the horizontal direction and the vertical direction as shown in FIG. 1 of Patent Document 1, and pairs of ground contacts arranged so as to intersect with the signal contacts in the horizontal direction and a single ground contact in between the signal contacts in the vertical direction, thus enabling connection of the male and female sides without having to enlarge the overall dimensions, while reducing crosstalk between signal lines in each direction.

Patent Document 2 describes an invention that was made to improve on conventional art differential transmission connectors wherein, in order to prevent crosstalk from adjacent differential transmission cables with drain lines, a pair of signal lines and a drain line are grouped together and shielded by a shield material, such that the pair of signal lines are aligned in the longitudinal direction, and a ground metal plate or the like is disposed so as to contact the drain line between that pair and another pair of signal lines that are adjacent in a lateral direction, thereby to improve the high-frequency characteristics. The invention has a shield plate connected to a drain line aligned in a direction roughly perpendicular to the axial direction of the signal contacts detained against a ground metal plate in a longitudinal direction between a pair of signal lines aligned in the longitudinal direction so as to be in a roughly intermediate position between a pair of signal contacts above and below. As a result, the drain lines of the cables are arranged by the shield plates to be organized in a required direction with the cable covers or the like, thus enabling them to be pressure connected together, while also detaining them and integrating them with the ground contact plates, so as to improve the transmission characteristics for high-speed transmission.

### Patent Document 1: JP 2002-246121 A

### Patent Document 2: JP 2003-257558 A

### DISCLOSURE OF THE INVENTION

### Problems to be Solved by the Invention

The connector structure disclosed in Patent Document 1 has multiple pin-shaped signal contacts arranged two-dimensionally, and this idea cannot be applied to a relatively small number of signal contacts that are arranged one-dimensionally. Additionally, connectors for the purpose of one-dimensional arrangements usually include shields surrounding the signal contacts, which is another reason the art disclosed in Patent Document 1 cannot be applied to connectors with one-dimensionally arranged signal contacts.

Additionally, the connector structure disclosed in Patent Document 2 has pairs of longitudinal signal lines arranged laterally, separated from other signal lines by shield plates contacting the drain lines, with the drain lines positioned at intermediate positions between the longitudinally aligned signal lines, and connected to a shield plate that forms a ground contact, but this differs from the structure of the present invention wherein a shield portion is formed by a shell surrounding a one-dimensional array of signal lines and a drain line, and like Patent Document 1, it cannot be applied to a connector in which the signal contacts are arranged one-dimensionally.

### Means for Solving the Problem

In conventional differential transmission connectors, the structure is usually one in which a pair of signal lines and one or more drain lines inside a differential transmission cable are arranged in a single row on the same carrier as signal lines and ground lines. However, the spacing between the electrical lines must inevitably be reduced in order to accommodate increases in the required number of signal lines, thus causing degradation of the signal characteristics due to crosstalk between signal lines. In view of the above problems, the present invention has the purpose of providing a shield effect to improve the impedance characteristics of the signal lines by positioning a shell covering the connection points of each electrical line corresponding to the electrical contacts in the connector, connecting the drain lines to improve the impedance characteristics of the signal lines, and eliminating the ground electrical contacts corresponding to the drain lines which have conventionally been connected to the drain lines at both ends to reduce the connector width, make the dimensions of the connector more compact overall and improve its characteristics.

According to a preferred embodiment of the present invention, the connector of the present invention is a connector that mates with a counterpart connector to perform electrical connection of at least two differential transmission cables each having a pair of signal lines and at least one drain line, wherein the aforementioned connector comprises a pair of adjacent signal line contacts to which a pair of signal lines of the aforementioned cable are connected, a ground line contact to which at least one drain line of the aforementioned cable is connected, a carrier having the aforementioned pairs of signal line contacts and the aforementioned ground line contacts arranged alternately in a single row in a width direction perpendicular to the axial direction of the aforementioned cable on the same plane, and a shell covering the aforementioned signal line contacts and the aforementioned ground line contacts as well as the aforementioned carrier, wherein a drain line positioned on at least one end of the aforementioned arrangement is connected to the aforementioned shell.

In a typical embodiment, for example, corresponding electrical contacts are arranged on the flat surface of a molded carrier such that two differential transmission cables having at least one drain line and two signal lines are aligned, with a pair of adjacent signal lines positioned on each side of the ground line. At least one drain line is connected to a ground electrical contact. The carrier and the electrical contacts are covered, for example, by a hollow metal shell having a shield effect. At least one drain line is connected to the metal shell. Stable signal transmission characteristics can be obtained by means of the above structure.

According to a preferred embodiment of the present invention, the connector of the present invention has drain lines positioned at both sides of the signal line contacts and ground line contact arranged on the carrier as described above, and both drain lines connected to the aforementioned shell.

When, for example, using a dual-drain differential transmission cable, drain lines are usually positioned on both sides of the cable. Therefore, when two cables are positioned side by side, drain lines will be positioned on the outsides of the signal lines and ground line arranged as described above, and these can be connected to the metal shell in order to achieve a more compact structure.

According to a preferable embodiment of the present invention, the aforementioned ground line contact of the connector of the present invention is connected with one drain line from each of the aforementioned cables.

When using a dual-drain differential transmission cable with two cables positioned side by side as described above, two drain lines will lie adjacent each other between a pair of signal lines from the cables, and when these are simultaneously connected to a single ground line contact, it is possible to arrange the lines so as to have a small spacing, thereby reducing the size of the connector overall.

According to a preferable embodiment of the present invention, the connector of the present invention is such that there are two of the aforementioned cables, each cable having drain lines on both sides of the pair of signal lines in the aforementioned arrangement plane, a portion of the aforementioned drain lines on both sides being connected to the aforementioned shell when configuring the two aforementioned cables, and the drain lines with pairs of signal lines on both sides being connected to a single ground line contact.

When two dual-drain differential transmission cables having drain lines on both sides of a pair of signal lines are positioned side by side, the drain lines positioned outermost on the arrangement are connected to the shell, and the other adjacent pairs of drain lines are connected to a single ground line contact as ground lines. Due to this structure, while conventional configurations have ground line contacts for each of the drain lines positioned outermost, in the present invention, they are connected to the shell, so that it is possible to eliminate two of the contacts, thus contributing to an overall reduction in the size of the connectors.

According to a preferable embodiment of the present invention, the combination of connectors of the present invention comprises any one of the connectors described above, and a counterpart connector having contacts corresponding to the contacts of the aforementioned connector on a carrier surrounded by a shell, such that the corresponding shells can be mated together to achieve an electrical connection.

The connector of the present invention is a complementary connector for connecting differential transmission cables for high-speed signal transmission, for example, for mating together a cable connector for electrically connecting a plurality of devices such as a hard disk and a CPU on a printed circuit board inside a personal computer, and a board connector provided on a circuit board for directly connecting with the devices. When mated together, the outer profiles of the metal shells are complementary, so that when one of the shells is inserted inside another hollow shell, the hollow shell covers the outer surface of the other shell. A carrier with an array of electrical contacts is provided inside each shell, and when mated together, the corresponding contacts contact each other to electrically connect the devices.

FIG. 9 shows an example of a connector applicable to a personal computer as described above. FIG. 9(b) is a top view of two differential transmission cables and fifteen arrayed power supply cables that are terminally wired with a so-called combo type connector on one end (b′ side), and terminally wired separately and independently on the other end (b″ side); FIG. 9(a) is a plan view of the side of the connector (b′ side) that is terminally wired by a combo connector in FIG. 9(b), as seen from the insertion direction. This combo connector is further mated with a connector provided on a hard disk, to complete a connection. As can be seen from the connector portion of the differential transmission cable of FIG. 9(a), there are a total of seven contacts. The contacts positioned outermost are for use as drain lines, the contact in the center is for use by the two adjacent drain lines, and the other contacts are for use by signal lines, a pair of which is positioned between each outermost contact and the contact in the center.

The present invention is directed to a connector for differential transmission cables which are separate and independent at the aforementioned other end corresponding to the board connector on the FIG. 9(c) side, wherein the number of contacts is five, since the aforementioned outermost drain lines shown in FIG. 9(a) are connected to the shell.

Here, the independent connector side (b″ side) of the present invention may also be used as a power supply connector, and when the differential transmission cable wiring and the aforementioned power supply cable wiring are both covered by a shell, the outermost drain lines can be connected to the shell. An example of a modified version of FIG. 9 is shown in FIG. 10. FIG. 10 shows an integrated connector (b″ side) having a total of twenty contacts, which can be arranged in groups of five each handling four cables in the differential transmission cable wiring of a connector based on the present invention. In this diagram, of the four potential cables, two four-wire cables 42 are provided for differential transmission, and the remaining portion is taken up by power lines, with five multi-wire power lines 50 being provided. The connector on the (b″) side may have the same wiring as in FIG. 9 (the drain lines on both sides connected to the shell) with regard to the aforementioned two differential transmission cables, or only one of the outermost drain lines can be connected to the shell, with the drain line on the side adjacent the power lines being connected to an optional separate group of contacts and used as a ground line. In the former case, 10 contacts are used, and in the latter case, 11 contacts are used. Additionally, with regard to the aforementioned five power lines 50, each line can be connected to a group of contacts. When providing power lines, a number of wires can be put together as needed and connected to the contacts as appropriate to supply power for the desired application. The power lines on the combo connector side of the (b′) side are connected to predetermined contacts, but they are not directly related to the present invention, so a detailed explanation shall not here be given. Herebelow, the structure of the cable connector wiring of the present invention corresponding to the board connector side of FIG. 9(c) shall be explained.

### BRIEF DESCRIPTION OF THE DRAWINGS

FIG. 1 shows the external appearance of a board connector and a cable connector complementing said board connector according to the present invention.

FIG. 2(a) is a top perspective view of a board connector according to the present invention. FIG. 2(b) is a lower perspective view of a board connector according to the present invention.

FIG. 3 is an exploded perspective view of the constituent elements of a board connector according to the present invention as shown in FIG. 2.

FIG. 4 is a partially enlarged perspective view of a cable connector according to the present invention.

FIG. 5 is an exploded perspective view of the cable connector of FIG. 4.

FIGS. 6(a)-(d) show steps in the assembly of the constituent elements of FIG. 5.

FIG. 7 is an enlarged view of the state immediately before the second mold member is covered in the final step of FIG. 6.

FIG. 8 shows the wiring for the case where at least three differential transmission cables are used.

FIG. 9 shows an example of a connector capable of being applied to a personal computer. FIG. 9(a) is a view from the insertion side, FIG. 9(b) is a top plan view, and FIG. 9(c) shows a board connector that mates with the differential transmission cable connector of the present invention.

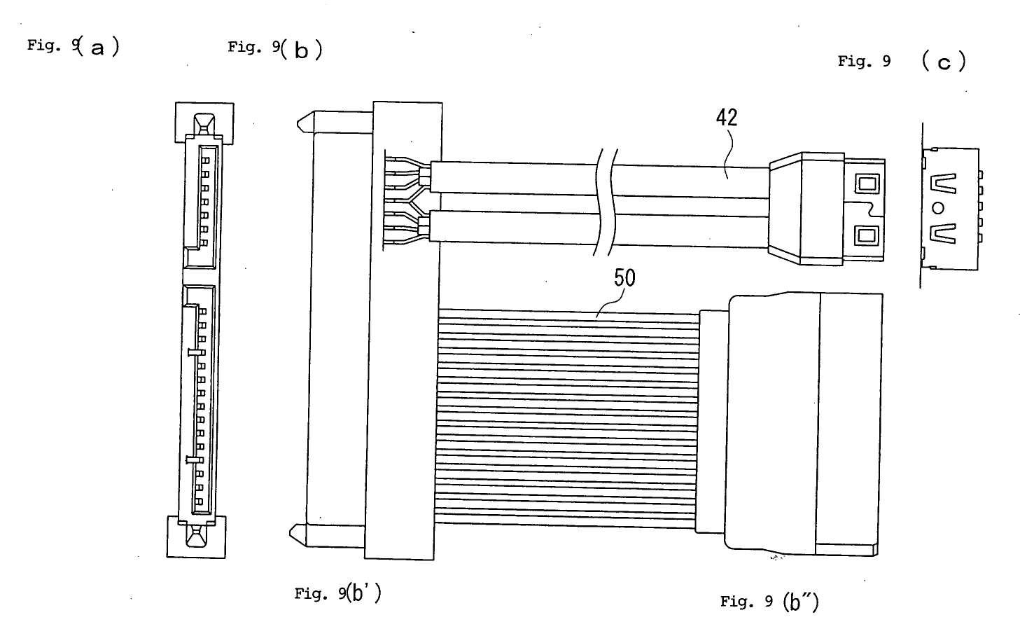

FIG. 10 shows a contact for wiring the differential transmission cables of connectors based on the present invention, for example, an integrated connector (b″ side) capable of being used as a power cable.

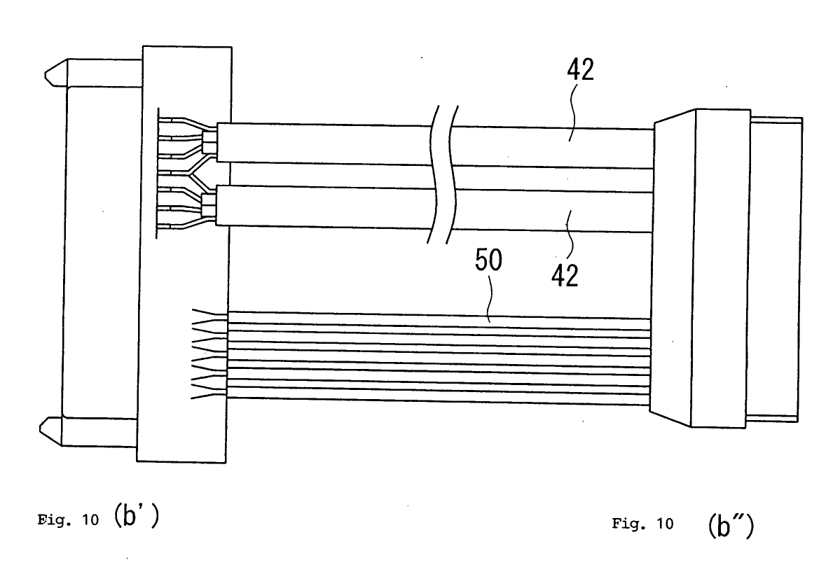

### EXPLANATION OF REFERENCE NUMBERS

20 . . . leg portion
22 . . . signal line contact
24 . . . ground line contact
26 . . . casing
27 . . . metal shell
28 . . . carrier
40 . . . metal shell
41 . . . first molded member
42 . . . differential transmission cable
43 . . . drain line
44 . . . ground line contact
45 . . . signal line
46 . . . signal line contact
48 . . . second molded member
49 . . . copper tape
50 . . . power line

### BEST MODES FOR CARRYING OUT THE INVENTION

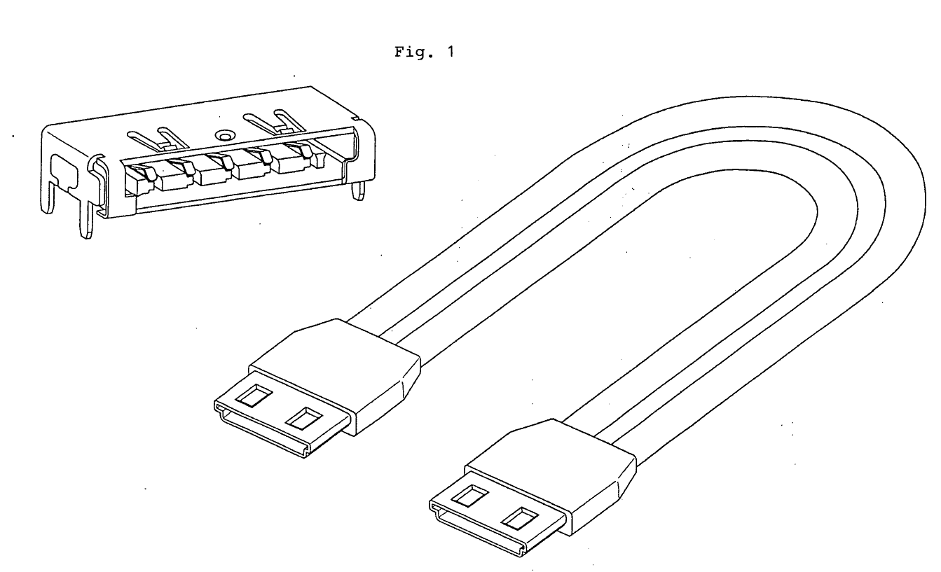

FIG. 1 is a perspective view of the external appearance of a board connector to be mounted on a circuit board, and a cable connector complementary to said board connector according to the present invention. The board connector is formed so as to be capable of accommodating the metal shell of the cable connector inside, and achieves an electrical connection when connected to a cable connector due to electrical contacts formed on the inside carrier coming into contact with corresponding electrical contacts.

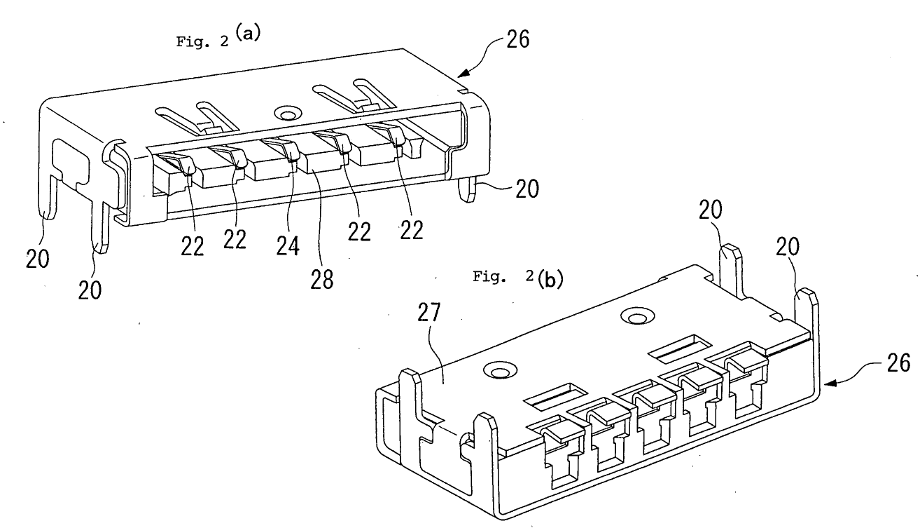

FIG. 2 shows a perspective view of the external appearance of a board connector according to the present invention. (a) is a top perspective view of a board connector according to the present invention. The casing 26 is open in the insertion direction of the cable connector, and is provided with four leg portions 20 for mounting on a circuit board that is not shown. Inside the casing 26, a carrier 28 is provided with two pairs of differential transmission signal line contacts 22 and one ground contact 24 arranged on the same plane in the width direction perpendicular to the direction of mating, such that when mated with a cable connector, the respective contacts engage with corresponding contacts. (b) is a bottom perspective view of a board connector according to the present invention. The external profile of the board connector of the present invention is formed by securing the casing 26 to the metal shell 27 having a bottom plate that contacts the ground portion when mounted on the circuit board. Additionally, at the reverse surface from the surface in which the cable connector is inserted, the leg portions of the contacts 22, 24 are worked into appropriate shapes to be connected and wired at predetermined positions on the circuit board when mounted on the circuit board.

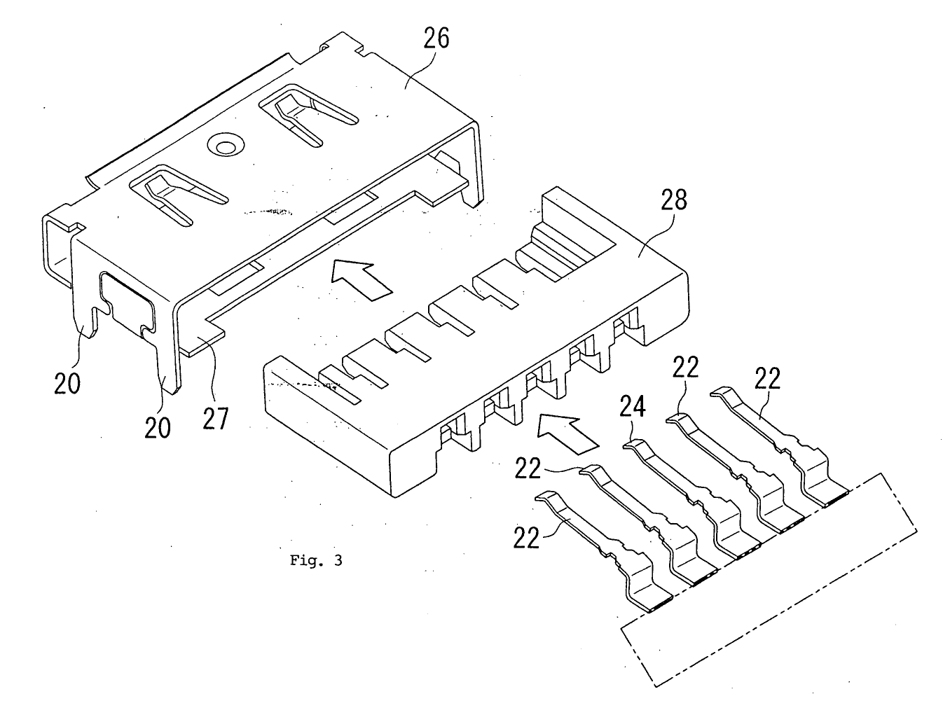

FIG. 3 is an exploded perspective view showing the constituent elements of the board connector of the present invention as shown in FIG. 2. The contacts 22, 24 are inserted into the carrier 28 from the surface opposite the surface on which the cable connector is inserted, and the assembly with the carrier 28 is completed when aligned on the same plane at a predetermined spacing with respect to the direction of insertion. Next, the assembled carrier 28 is similarly inserted into the assembly of the casing 26 and the metal shell 27 from the surface opposite the surface where the cable connector is inserted, thus completing the assembly of the board connector of the present invention.

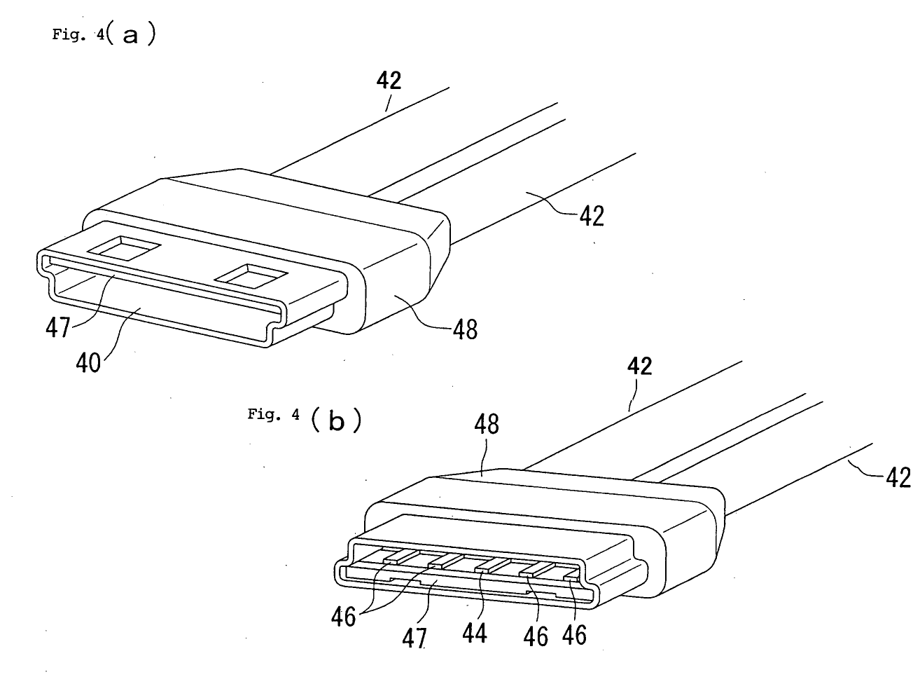

FIG. 4 is a partially enlarged perspective view of a cable connector according to the present invention. (a) is a perspective view showing a front side to be connected with the board connector, wherein a carrier 47 carrying the contacts 44, 46 is provided on the top plate side of the metal shell 40. An insulation molded member 48 covers a portion of the cable 42 and a portion of the metal shell 40 which covers the entirety of the contacts 44, 46 and the carrier 47, and when mated into connection with the board connector, predetermined portions in opposition come into contact with the open edge portions of the board connectors, and thereby prevent the metal shell 40 from being pressed further than a predetermined position inside the board connector. (b) shows a 180 degree inversion of the positions in (a), wherein a total of two pairs of signal line contacts 46 connected to a pair of signal lines inside each cable 42 and a ground line contact 44 connected to one drain line in each cable are provided on the carrier 47. When mated into connection with the board connector, the corresponding contacts engage with each other (22 and 46; 24 and 44).

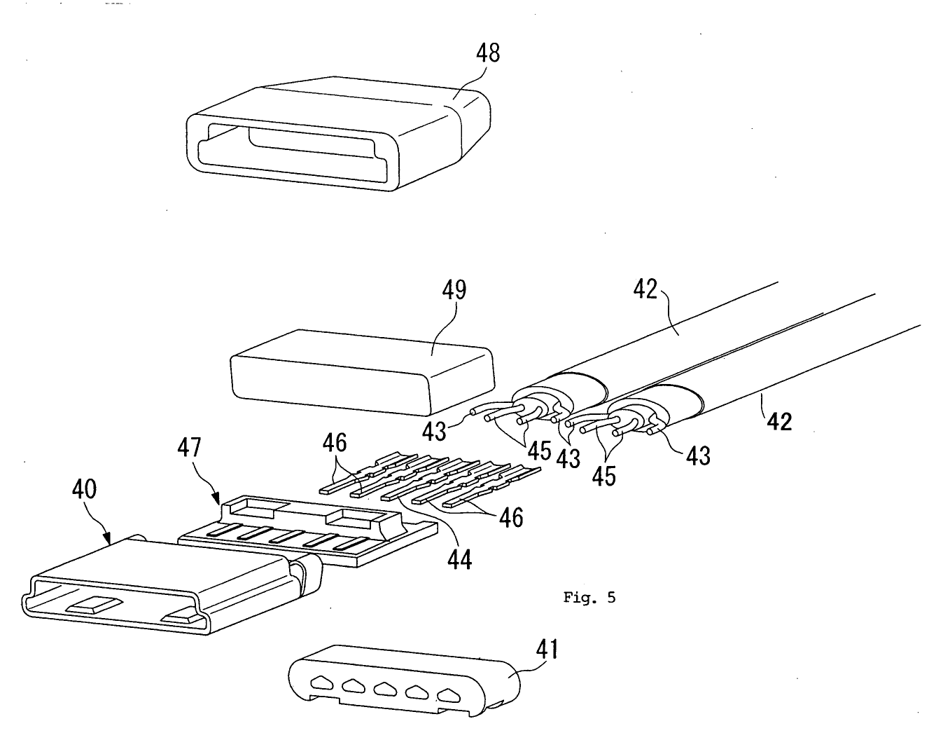

FIG. 5 is an exploded perspective view of the cable connector of FIG. 4, for explaining the constituent elements. Two cables 42 are provided side by side, and inside each cable are provided a pair of signal lines 45, and drain lines 43 on both sides of said pair of signal lines 45. The group of contacts is composed of a ground line contact 44 to which two drain lines are simultaneously connected, and two pairs of signal line contacts 46, a pair on each side thereof, so as to have a total of five contacts for one connector. As shown in FIG. 4, the contacts 44, 46, carrier 47 and metal shell 40 are sequentially assembled, then covered by the first molded member 41, copper tape 49, and the second molded member 48 for completion.

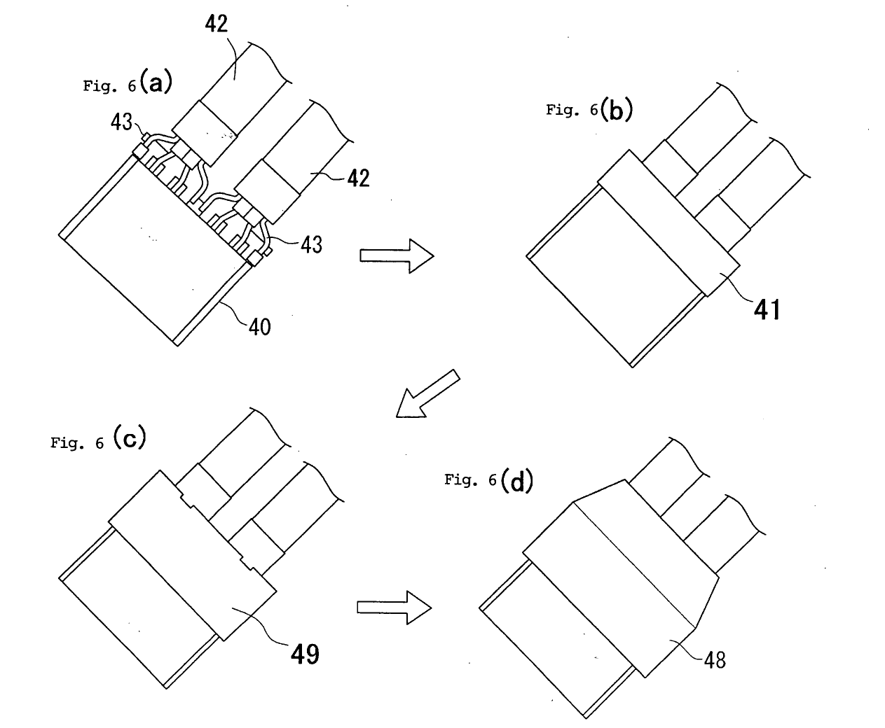

FIG. 6 shows the process of assembly of the constituent elements in FIG. 5 in detail. FIG. 6(a) shows that a group of contacts including the ground line contact 44 and signal line contacts 46 are aligned on the aforementioned carrier 47, the electrical lines inside each cable 42 are soldered to the respective contacts, and the two drain lines positioned between the signal lines are soldered to the single ground line contact, then the carrier 47 is covered by the metal shell 40 while simultaneously soldering the drain lines 43 positioned outermost to the metal shell 40. Then, FIG. 6(b) shows the exposed portion between the metal shell 40 and the terminal portion of the cable 42 being covered by the first molded member 41. Next, FIG. 6(c) shows the molded member 41 being covered by a copper tape 49. Finally, FIG. 6(d) shows the copper tape 49 being covered by the second molded member 48 for completion.

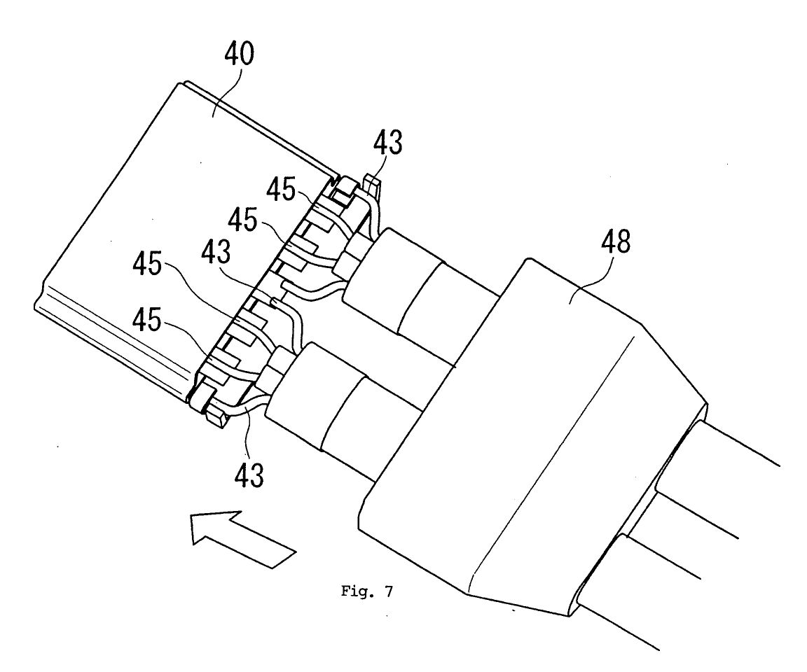

FIG. 7 shows an enlarged view immediately before the metal shell and the terminal portion of the cable are assembled by covering with the first molded member 41, the copper tape 49 and the second molded member 48 in FIG. 6. As mentioned previously, two cables housing a total of four electrical lines 43, 45 are placed side by side, and two drain lines 43 are positioned on both sides of the pair of signal lines 45 to provide a total of eight electrical lines in the width direction perpendicular to the axial direction of the cable. The two drain lines 43 positioned outermost are soldered to the metal shell 40. Additionally, the total of two pairs of signal lines 45 are soldered for connection to the signal line contacts 46. Furthermore, the pair of drain lines 43 each extending from a cable, and having a pair of signal lines on both sides are soldered to the same ground line contact 44. Due to this arrangement, the metal shell 40 having a shield effect covers the two pairs of signal lines 45 and the pair of ground drain lines 43, thus reducing signal noise caused by crosstalk between the signal lines or unmatched impedances due to connections between the groups of contacts and the electrical lines.

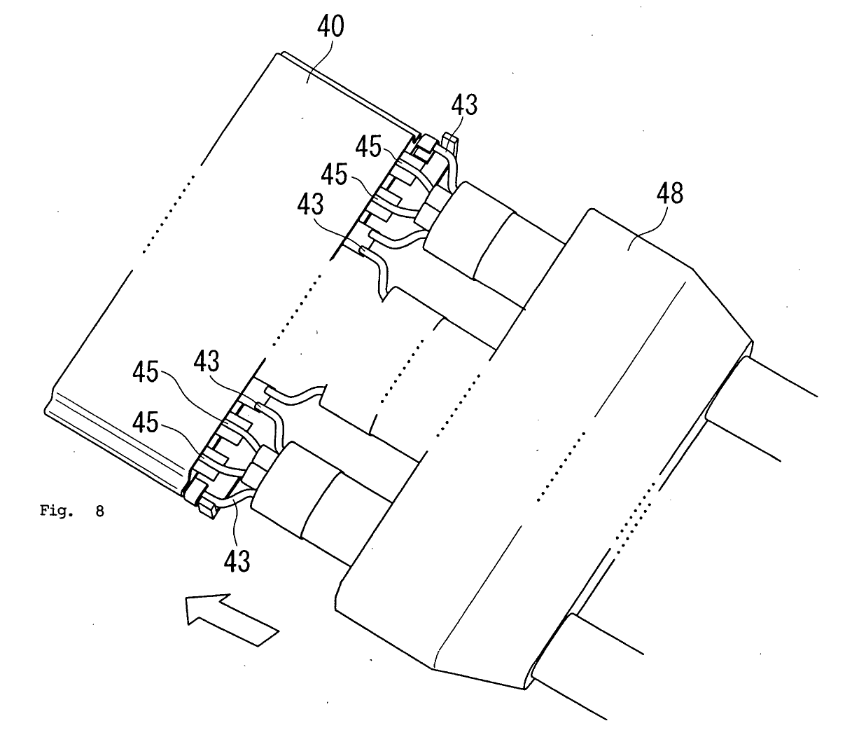

FIG. 7 explains the wiring for the case where two differential transmission cables are used. FIG. 8 shows the wiring for the case where three or more differential transmission cables are used, with the drain lines on both sides connected to the shield 40, and the other adjacent pairs of drain lines 43 connected to a single ground electrical contact.

Due to this structure, while ground electrical contacts have been conventionally provided for the drain lines positioned outermost, in the present invention, the outermost drain lines are directly connected to the shield 40, thus enabling the two ground electrical contacts conventionally positioned outermost to be eliminated, thereby reducing the length in the width direction perpendicular to the axial direction of the cable. As a result, it is possible to make the dimensions of the connector more compact.

Additionally, together with improvements in cable technologies, careful selection of the performance of the cables used and employment of the connectors of the present invention resulted in compact, high-performance connectors.

1. A connector that mates with a counterpart connector to perform electrical connection of at least two differential transmission cables each having a pair of signal lines and at least one drain line;
said connector comprising a pair of adjacent signal line contacts to which a pair of signal lines of the cable are connected, a ground line contact to which at least one drain line of said cables is connected, a carrier having said pairs of signal line contacts and said ground line contacts arranged alternately in a single row in a width direction perpendicular to the axial direction of said cable on the same plane, and a shell covering said signal line contacts and said ground line contacts as well as said carrier;
wherein a drain line positioned on at least one end of the aforementioned arrangement is connected to the aforementioned shell.

2. A connector in accordance with claim 1, wherein a drain line is positioned on each side of said arrangement, and both drain lines are connected to said shell.

3. A connector in accordance with claim 1, wherein said ground line contacts each have one drain line of the cable connected thereto.

4. A connector in accordance with claim 1, comprising two of said cables, each cable having a drain line on each side of a pair of signal lines with respect to said arrangement plane, such that when said two cables are positioned, portions of the drain lines on both sides are connected to said shell, and the drain lines having a pair of signal lines on both sides are connected to a single ground line contact.

5. A pair of connectors consisting of a connector in accordance with claim 1, and a counterpart connector having contacts corresponding to the contacts of the aforementioned connector on a carrier surrounded by a shell, such that the corresponding shells can be mated together to achieve an electrical connection.
